(19) United States
(12) Patent Application Publication
(10) Pub. No.: US 2004/0080252 A1
(43) Pub. Date: Apr. 29, 2004

(54) Spark plug for use in internal combustion engine

(75) Inventors: Satoko Ito, Aichi (JP); Kenji Kobayashi, Aichi (JP); Kenichi Kumagai, Aichi (JP); Wataru Matsutani, Aichi (JP); Yoshihiro Matsubara, Mie (JP)

Correspondence Address: KUSNER & JAFFE, HIGHLAND PLACE SUITE 310, 6151 WILSON MILLS ROAD, HIGHLAND HEIGHTS, OH, 44143, US

(73) Assignee: NGK Spark Plug Co., Ltd.

(21) Appl. No.: 10/668,567

(22) Filed: Sep. 23, 2003

(30) Foreign Application Priority Data
Oct. 25, 2002 (JP) JP2002-310610
Jun. 18, 2003 (JP) JP2003-173412

(51) Int. Cl. H01T 13/20

(52) U.S. Cl. 313/141

(57) ABSTRACT

A spark plug for use in an internal combustion engine includes a tubular insulator having an axial hole extending therethrough; a center electrode fitted into the axial hole and having a distal end portion protruding from a distal end of the insulator; and a ground electrode arranged such that at least a portion of spark discharge generated between the ground electrode and the distal end portion of the center electrode includes creeping discharge along the surface of the distal end portion of the insulator. The distal end portion of the center electrode contains Ni as a primary component in an amount of 80 wt % or more and Fe and Cr as secondary components in a total amount of 2.5 wt % to 10.0 wt % and further contains Al as a secondary component in an amount of 0.2 wt % to 0.8 wt %.

### FIELD OF THE INVENTION

The present invention relates to a spark plug for use in an internal combustion engine, and more particularly to a spark plug for use in an internal combustion engine in which spark discharge including creeping discharge along the surface of a distal end portion of an insulator is generated.

### BACKGROUND OF THE INVENTION

In recent years, improvements in engine performance have led to demand for further extension of life and enhancement of fouling resistance of a spark plug for use in an internal combustion engine. For example, a so-called semi-creeping-discharge spark plug is known as a spark plug for use in an internal combustion engine which exhibits improved fouling resistance (see Japanese Patent Application Laid-Open (kokai) No. 2001-68252 (pp. 5-9, FIG. 1), and Japanese Patent Application Laid-Open (kokai) No. 2002-164146 (pp. 7-11, FIG. 1)). Such a semi-creeping-discharge spark plug for use in an internal combustion engine is configured such that a spark is generated between the ground electrode and the insulator in the form of gaseous discharge and propagates between the insulator and the center electrode in the form of creeping discharge along the surface of a distal end portion of the insulator. Generally, when a spark plug for use in an internal combustion engine is used for a long period of time in a low-temperature environment, the spark plug assumes a so-called “carbon fouling” or “fuel fouling” condition; i.e., the surface of a distal end portion of the insulator is covered with an electrically conductive fouling substance such as carbon. Hence, the spark plug is prone to defective operation. By contrast, in the above-mentioned semi-creeping-discharge spark plug, creeping discharge along the surface of a distal end portion of the insulator burns off a fouling substance such as carbon, whereby excellent fouling resistance is exhibited.

Meanwhile, a semi-creeping-discharge spark plug is known to involve a phenomenon in which, upon frequent occurrence of creeping discharge along the surface of a distal end portion of the insulator, the surface of the distal end portion of the insulator tends to be ablated in the form of a channel; i.e., so-called channeling tends to occur. Progress of channeling is apt to cause a problem in a spark plug, such as impairment in heat resistance or reliability. In order to suppress channeling, a spark plug for use in an internal combustion engine is known to be configured such that an Ni alloy which contains Fe and Cr as secondary components is used to form a center electrode (see, for example, Japanese Patent Application Laid-Open No. 2001-68252). This spark plug utilizes a phenomenon in which oxides of Fe and Cr form semiconductors. Specifically, spark erosion of the center electrode associated with spark discharge involves sputtering of Fe and Cr. Such sputtering Fe and Cr adhere to the surface of a distal end portion of the insulator and form a coating layer consisting of oxide semiconductors. The coating layer protects the insulator and brings about a reduction in discharge voltage, thereby suppressing channeling.

However, since the thermal conductivity of the center electrode lowers as the amount of added Fe and Cr increases, an increase in the amount of added Fe and Cr accelerates erosion of the center electrode. Conceivably, erosion of the center electrode involves two factors, namely spark erosion and oxidational erosion. In this connection, there is known a spark plug for use in an internal combustion engine which can suppress channeling as well as erosion of the center electrode through adjustment of Fe and Cr contents (see, for example, Japanese Patent Application Laid-Open No. 2002-164146). In this spark plug for use in an internal combustion engine, Fe is contained in an amount of 1.0 wt % or more; Cr is contained in an amount of 1.5 wt % or more; the total amount of Fe and Cr is 2.5 wt % to 9.0 wt %; and Ni is contained in an amount of 80 wt % or more, thereby suppressing channeling as well as erosion of the center electrode. This spark plug for use in an internal combustion engine is characterized in that elements which form oxide semiconductors are used as secondary components of a Ni alloy and that Fe and Cr are used as the optimum accessory elements. However, even when the Fe and Cr contents are adjusted, erosion of the center electrode fails to be sufficiently suppressed.

### SUMMARY OF THE INVENTION

The present invention is accomplished in view of the foregoing, and an advantage of the invention is a spark plug for use in an internal combustion engine which can suppress both channeling of the insulator and erosion of the center electrode.

The present invention provides a spark plug for use in an internal combustion engine comprising a tubular insulator having an axial hole extending therethrough in an axial direction; a center electrode fitted into the axial hole and having a distal end portion protruding from a distal end of the insulator; and a single or a plurality of ground electrodes located diametrally outside of the center electrode and positionally related to a distal end portion of the insulator and the distal end portion of the center electrode such that at least a portion of spark discharge generated between the ground electrode(s) and the distal end portion of the center electrode includes creeping discharge along a surface of the distal end portion of the insulator. At least the distal end portion of the center electrode is configured such that at least a surface of the distal end portion of the center electrode is formed of an Ni alloy which contains Ni as a primary component in an amount of 80 wt % or more and Fe and Cr as secondary components in a total amount of 2.5 wt % to 10.0 wt %. The Ni alloy further contains Al as a secondary component in an amount of 0.2 wt % to 0.8 wt %.

In a conventional spark plug for use in an internal combustion engine, elements, such as Fe and Cr, which form oxide semiconductors, are added as secondary components of a Ni alloy used to form a center electrode. Therefore, when the center electrode is eroded by spark, a coating layer consisting of oxide semiconductors is formed on the surface of a distal end portion of an insulator. The thus-formed coating layer protects the insulator and brings about a reduction in discharge voltage, thereby suppressing channeling. Therefore, addition, as a secondary component of the Ni alloy, of an element whose oxide is electrically insulative, such as Al, is unfavorable, and thus has not been considered.

By contrast, in the spark plug for use in an internal combustion engine of the present invention, at least a distal end portion of the center electrode is configured such that an Ni alloy used to form at least a surface of the distal end portion of the center electrode contains Al as a secondary component in an amount of 0.2 wt % to 0.8 wt % in addition to Fe and Cr, each serving as a secondary component. Addition of Al, whose thermal conductivity is high, in an amount of 0.2 wt % or more prevents a reduction in thermal conductivity of the Ni alloy which would otherwise result from addition of Fe and Cr, thereby suppressing erosion of the center electrode. Furthermore, specifying an upper limit of 0.8 wt % for the Al content suppresses the amount of a highly electrically insulative oxide of Al (A1₂O₃) contained in a coating layer formed on the surface of a distal end portion of the insulator so as to maintain the electrical conductivity of the coating layer, thereby suppressing channeling.

The spark plug for use in an internal combustion engine of the present invention assumes the form of, for example, a semi-creeping-discharge spark plug in which spark discharge is generated in the form of gaseous discharge between the ground electrode and the insulator and in the form of creeping discharge along the surface of a distal end portion of the insulator between the insulator and the center electrode. The spark plug for use in an internal combustion engine of the present invention may assume the form of a semi-creeping-discharge spark plug combined with a parallel electrode which faces the distal end face of the center electrode, or the form of a full-creeping-discharge spark plug in which creeping discharge is generated between the center electrode and the annular ground electrode surrounding the insulator without involvement of gaseous discharge. The present invention encompasses all types of spark plugs for internal combustion engines in which at least creeping discharge along the surface of a distal end portion of the insulator is generated.

In the above-mentioned semi-creeping-discharge spark plug combined with a parallel electrode which faces the distal end face of the center electrode, in order to enhance ignition performance and durability, a metal chip may be provided on the end of a distal end portion of the center electrode (on the distal end face of the center electrode). Notably, the metal chip does not constitute (i.e., is not a portion of) the distal end portion of the center electrode. The metal chip is formed of, for example, an alloy which contains as a primary component a noble metal, such as Pt, Ir, or Rh, or an alloy which contains as a primary component a high-melting-point metal, such as W.

Preferably, in the above-described spark plug for use in an internal combustion engine of the present invention, the single ground electrode or at least one of the plurality of ground electrodes is disposed such that a distal end face of the ground electrode faces a portion of a circumferential surface of the distal end portion of the center electrode while at least a part of the distal end portion of the insulator intervenes therebetween.

The spark plug for use in an internal combustion engine of the present invention assumes the form of, for example, a semi-creeping-discharge spark plug. In the semi-creeping-discharge spark plug, since the distal end face of the ground electrode faces a portion of the circumferential surface of the distal end portion of the center electrode while at least a part of the distal end portion of the insulator intervenes therebetween, spark discharge concentrates on that portion of the circumferential surface of the distal end portion of the center electrode via a portion of the circumferential surface of the distal end portion of the insulator. Hence, among spark plugs for use in an internal combustion engine in which creeping discharge is generated, a conventional semi-creeping-discharge spark plug is particularly susceptible to channeling and erosion of the center electrode. By contrast, as mentioned previously, in the spark plug for use in an internal combustion engine of the present invention, an Ni alloy used to form at least a distal end portion of the center electrode contains Al as a secondary component in an amount of 0.2 wt % to 0.8 wt % in addition to the secondary components of Fe and Cr, thereby suppressing channeling and erosion of the center electrode.

The spark plug for use in an internal combustion engine of the present invention is not limited to a semi-creeping-discharge spark plug, but may assume the form of a semi-creeping-discharge spark plug combined with a parallel electrode which faces the distal end face of a center electrode. In this spark plug, as mentioned previously, a metal chip may be provided on the end of a distal end portion of the center electrode (on the distal end face of the center electrode).

Preferably, in any one of the above-described spark plugs for use in an internal combustion engine of the present invention, the Ni alloy contains Fe, as a secondary component, in an amount of 1.5 wt % to 5.0 wt %.

As mentioned previously, Al contained in the Ni alloy as a secondary component forms a highly electrically insulative oxide (Al₂O₃). As a result of inclusion of A1₂O₃ in a coating layer formed on the surface of a distal end portion of the insulator, the electrical conductivity of the coating layer lowers. By contrast, in the spark plug for use in an internal combustion engine of the present invention, the Ni alloy contains Fe as a secondary component in an amount of 1.5 wt % to 5.0 wt %. Employment of an Fe content of 1.5 wt % or more suppresses a reduction in the electrical conductivity of the coating layer which would otherwise result from inclusion of a highly electrically insulative oxide of Al (Al₂O₃), whereby the coating layer formed on the surface of a distal end portion of the insulator can yield the effect of suppressing channeling. Specifying an upper limit of 5.0 wt % for the Fe content suppresses a reduction in the thermal conductivity of the Ni alloy, whereby erosion of the center electrode can be suppressed.

Preferably, in any one of the above-described spark plugs for use in an internal combustion engine of the present invention, the Ni alloy contains Cr, as a secondary component, in an amount of 1.5 wt % to 5.0 wt %.

In the spark plug for use in an internal combustion engine of the present invention, the Ni alloy contains Cr as a secondary component in an amount of 1.5 wt % to 5.0 wt %. Employment of a Cr content of 1.5 wt % or more suppresses a reduction in the electrical conductivity of the coating layer which would otherwise result from inclusion of a highly electrically insulative oxide of Al (Al₂O₃), whereby the coating layer formed on the surface of a distal end portion of the insulator can yield the effect of suppressing channeling. Specifying an upper limit of 5.0 wt % for the Cr content suppresses a reduction in the thermal conductivity of the Ni alloy, whereby erosion of the center electrode can be suppressed.

Preferably, in any one of the above-described spark plugs for use in an internal combustion engine of the present invention, the Ni alloy contains at least any one of Mn, Cu, and Co as a secondary component.

Generally, a composite oxide which contains an oxide of Al and an oxide of Mn, Cu, or Co is known to assume the form of a semiconductor. Thus, in the spark plug for use in an internal combustion engine of the present invention, in addition to Al, at least any one of Mn, Cu, and Co is added as a secondary component of the Ni alloy. By so doing, the coating layer formed on the surface of a distal end portion of the insulator contains, in place of a highly electrically insulative oxide of Al (Al₂O₃), a composite oxide semiconductor which contains an oxide of Al as a component (e.g., a composite oxide semiconductor consisting of aluminum oxide and manganese oxide). Thus, the electrical conductivity of the coating layer is enhanced, whereby discharge voltage lowers, thereby suppressing channeling more effectively.

Preferably, in any one of the above-described spark plugs for use in an internal combustion engine of the present invention, when b represents the content (wt %) of Al, and c represents the total of Mn, Cu, and Co contents (wt %), the Ni alloy satisfies the relationship 0.3b≦c≦6.0b.

In the spark plug for use in an internal combustion engine of the present invention, when b represents the content (wt %) of Al, and c represents the total of Mn, Cu, and Co contents (wt %), the Ni alloy is prepared to satisfy the relationship 0.3b≦c≦6.0b. Through addition of Mn, Cu, and Co in a total amount of 0.3 times or more the weight of Al, a composite oxide semiconductor which contains an oxide of Al as a component and which effectively suppresses channeling (e.g., a composite oxide semiconductor consisting of aluminum oxide and manganese oxide) is formed on the surface of a distal end portion of the insulator. Specifying an upper limit of 6.0 times the weight of Al for the total weight of Mn, Cu, and Co ensures erosion resistance and thermal resistance of the center electrode.

Preferably, in any one of the above-described spark plugs for use in an internal combustion engine of the present invention, the center electrode comprises a core member formed of Cu or a Cu alloy, and a covering member formed of the Ni alloy and covering at least a distal end portion of the core member such that a distal end of the core member is located on a proximal side with respect to a distal end face of the center electrode; and the Ni alloy contains C as a secondary component in an amount of 0.003 wt % to 0.05 wt %.

In some cases, the center electrode of a spark plug for use in an internal combustion engine may assume a one-piece structure consisting of a core member formed of Cu or a Cu alloy, and a covering member formed of a Ni alloy and covering a distal end portion of the core member.

The core member formed of Cu or a Cu alloy is greater in coefficient of thermal expansion than the covering member formed of a Ni alloy and covering the core member. Thus, in actual use of a spark plug having the thus-configured center electrode, the radially outward thermal expansion of the core member may cause a portion of the covering member (hereinafter may be referred to as a “peripheral covering portion”) located around the periphery of the core member to expand radially outward to a greater extent as compared with characteristic thermal expansion of the Ni alloy. Meanwhile, a portion of the covering member (hereinafter may be referred to as a “distal covering portion”) located on a distal end side with respect to the core member thermally expands radially outward at a rate characteristic to the Ni alloy without being influenced by radially outward thermal expansion of the core member. For this reason, the covering member may involve the following problem: the peripheral covering portion expands radially outward to a greater extent as compared with the distal covering portion and leads to deformation or fracture, and a distal end portion of the center electrode is deformed in such a manner as to sink toward a proximal side.

By contrast, in the spark plug for use in an internal combustion engine of the present invention, the Ni alloy used to form the covering member of the center electrode contains C as a secondary component in an amount of 0.003 wt % to 0.05 wt %. Employment of a C content of 0.003 wt % or more enhances the hot strength of the Ni alloy, thereby suppressing great, radially outward expansion and resultant deformation of the peripheral covering portion located around the periphery of the core member which would otherwise result from influence of the thermal expansion of the core member. Thus, there can be suppressed the problem of a distal end portion of the center electrode being deformed in such a manner as to sink toward the proximal side. Furthermore, specifying an upper limit of 0.05 wt % for the C content suppresses an impairment in the formability of the center electrode which would otherwise result from excessively high hardness of the Ni alloy. Notably, the core member is disposed either such that its distal end is located on the proximal side with respect to the distal end of the insulator and does not extend into a distal end portion of the center electrode, or such that its distal end is located in such a manner as to protrude beyond the distal end of the insulator and thus extends into the distal end portion of the center electrode.

Preferably, any one of the above-described spark plugs for use in an internal combustion engine of the present invention further comprises a metallic shell disposed in such a manner as to surround a periphery of the insulator and such that the distal end portion of the insulator protrudes beyond a distal end face of the metallic shell; and a distal end of the metallic shell has an outside diameter of 10.1 mm or less.

In recent years, in order to cope with increased output of an internal combustion engine, increasing the size of an intake valve and an exhaust valve within a combustion chamber and employment of a 4-valve system has been studied. Also, since engine sizes tend to decrease, a reduction in the size of a spark plug for use in an internal combustion engine been desired. However, in the case of a spark plug which involves creeping discharge, such as a semi-creeping-discharge spark plug, the greater the reduction in the size (diameter), the greater the degree of creeping discharge. Also, in general, the greater the reduction in size (diameter), the greater the reduction in wall thickness of the insulator. Thus, the problem of channeling becomes serious particularly when a male-threaded portion of the metallic shell assumes a size of M12 or less.

By contrast, in the semi-creeping-discharge spark plug of the present invention, since the center electrode is formed of an Ni alloy containing the aforementioned components, even when the outside diameter of the distal end of the metallic shell is 10.1 mm or less (equivalent to the outside diameter of the distal end of a metallic shell whose male-threaded portion has a diameter of M12 or less), channeling can be suppressed.

Notably, the outside diameter of the distal end of a metallic shell means the diameter of the distal end excluding a chamfered portion formed at a distal end edge of the metallic shell. Therefore, the present invention can be applied to a spark plug whose metallic shell does not have a mounting male-threaded portion on its outer surface, or a so-called unthreaded plug.

### BRIEF DESCRIPTION OF THE DRAWINGS

FIG. 1 is a side view of a spark plug according to an embodiment of the present invention;

FIG. 2 is a sectional view showing the structure of a main portion of the spark plug according to the embodiment;

FIG. 3 is a top view showing the structure of the essential portion of the spark plug according to the embodiment;

FIGS. 4A and 4B are explanatory views showing the action of the spark plug according to the embodiment;

FIG. 5 is a table showing the results of an evaluation test on the spark plug according to the embodiment for erosion resistance of the center electrode and channeling resistance of the insulator;

FIG. 6 is a table showing the results of an evaluation test on the spark plug according to the embodiment for sink resistance of the center electrode;

FIGS. 7A and 7B are views showing the structure of a main portion of a spark plug according to a first modification, wherein FIG. 7A is a sectional front view, and FIG. 7B is a sectional side view; and

FIGS. 8A and 8B are views showing the structure of a main portion of a spark plug according to a second modification, wherein FIG. 8A is a sectional front view, and FIG. 8B is an enlarged view of FIG. 8A.

### DESCRIPTION OF PREFERRED EMBODIMENT

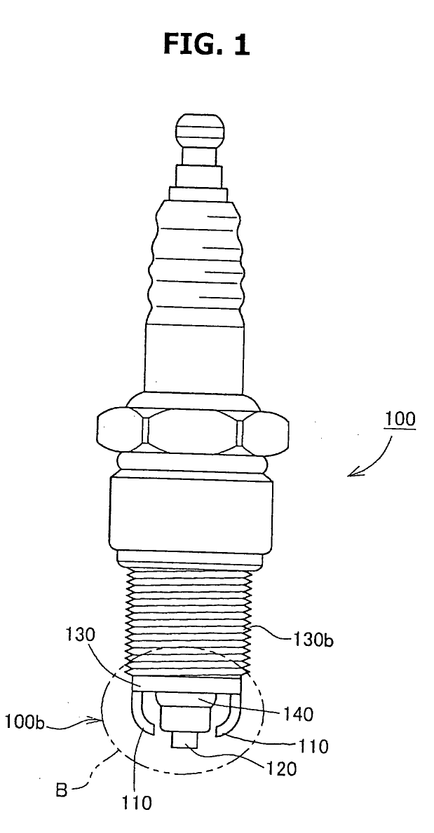

A spark plug 100 according to an embodiment of the present invention will be described with reference to the drawings. As shown in FIG. 1, the spark plug 100 includes two ground electrodes 110, a center electrode 120, a metallic shell 130, and an insulator 140. The spark plug 100 is mounted on the cylinder head of an unillustrated engine through utilization of a malethreaded portion 130b formed on the outer circumferential surface of the metallic shell 130.

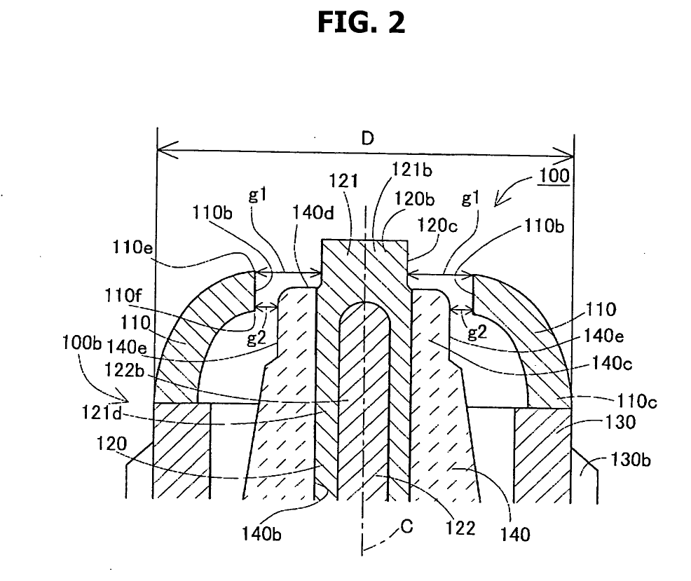

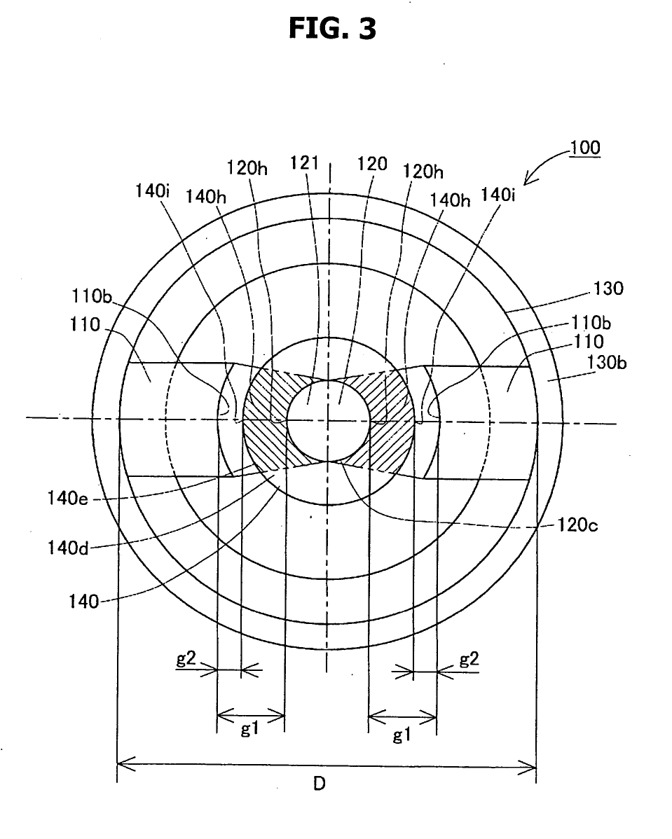

FIGS. 2 and 3 are a sectional view and a top view, respectively, showing a main portion of the present invention; i.e., a distal end portion 100b (portion B in FIG. 1) of the spark plug 100. The insulator 140 is a tubular member formed of alumina and having an axial hole 140b extending therethrough along an axis C. The center electrode 120 is a rodlike metal member which is fixedly fitted into the axial hole 140b such that a distal end portion 120b of the center electrode 120 protrudes toward the distal end side beyond a distal end face 140d of the insulator 140. The metallic shell 130 has a male-threaded portion 130b of a nominal size of M14 formed on its outer circumferential surface and surrounds the periphery of the insulator 140 with a gap formed therebetween. In the present embodiment, the distal end of the metallic shell 130 has an outside diameter D of 12.05 mm. The ground electrodes 110 are each a metal member, and are provided at opposed positions such that the center electrode 120 intervenes therebetween. More specifically, proximal end portions 110c of the ground electrodes 110 are welded to the metallic shell 130 (see FIG. 2), while, as shown in FIG. 3, a distal end face 110b of each ground electrode 110 faces a facing portion 120h of the center electrode 120—the facing portion 120h being a portion of a side surface (circumferential surface) 120c of a distal end portion (hereinafter referred to as the “distal end side surface 120c”) of the center electrode 120.

Furthermore, in the spark plug 100, as shown in FIG. 2, a distal end portion 140c of the insulator 140 is disposed in such a manner as to intervene between the distal end side surface 120c of the center electrode 120 and the distal end faces 110b of the ground electrodes 110. More specifically, as viewed along the axis C, the distal end face 140d of the insulator 140 is located between a proximal edge portion 110f and a distal edge portion 110e of the distal end face 110b of each ground electrode 110. Notably, the gap between the distal end side surface 120c of the center electrode 120 and the distal end face 110b of each ground electrode 110 is called a first gap g1, and the gap between a side surface 140e of a distal end portion (hereinafter referred to as the “distal end side surface 140e”) of the insulator 140 and the distal end face 110b of each ground electrode 110 is called a second gap g2.

Furthermore, in the spark plug 100, the center electrode 120 assumes a one-piece structure consisting of a core member 122 and a covering member 121. The core member 122 extends such that its axis coincides with the axis C, and is formed of Cu so as to enhance heat release from the center electrode 120. The covering member 121 covers a distal end portion 122b of the core member 122 and is formed of a Ni alloy. The Ni alloy used to form the covering member 121 contains Ni as a primary component and Fe, Cr, Al, and the like as secondary components. Components of the Ni alloy will be described in detail later. In the spark plug 100 of the present embodiment, the core member 122 is configured such that its distal end is located on the proximal side with respect to the distal end face 140d of the insulator 140 and does not extend into the distal end portion 120b of the center electrode 120. Therefore, the entire distal end portion 120b of the center electrode 120 is formed of the Ni alloy. Notably, in the present embodiment, the ground electrodes 110 are also formed of a Ni alloy similar to that used to form the covering member 121 of the center electrode 120.

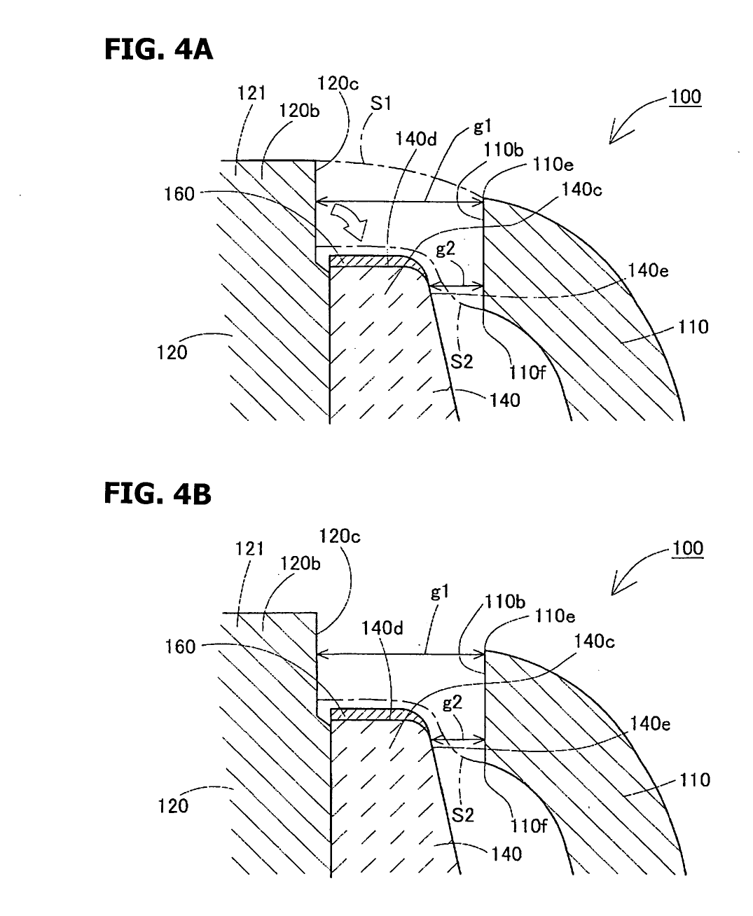

Next, a state in which the spark plug 100 is used in an internal combustion engine will be described. The spark plug 100 is mounted on an unillustrated cylinder head of an engine through utilization of the male-threaded portion 130b formed on the metallic shell 130 and is used as an ignition source for igniting an air-fuel mixture fed into a combustion chamber. A high discharge voltage is applied to the spark plug 100, for example, such that the center electrode 120 serves as a negative electrode, and the ground electrodes 110 serves as a positive electrode. As a result, as shown in FIG. 4A, a spark discharge S1 is generated in the form of gaseous discharge across the first gap g1; i.e., between the distal end face 110b of each ground electrode 110 and the distal end side surface 120c of the center electrode 120, thereby igniting an air-fuel mixture contained in an unillustrated combustion chamber. Alternatively, a spark discharge S2 is generated in the combined form of creeping discharge along the distal end face 140d and the distal end side surface 140e of the insulator 140 and gaseous discharge across the second gap g2; i.e., between the distal end face 110b of each ground electrode 110 and the distal end side surface 140e of the insulator 140, thereby igniting the air-fuel mixture contained in the unillustrated combustion chamber.

As described above, the spark plug 100 functions as a so-called semi-creeping-discharge spark plug in that gaseous discharge is generated between the distal end faces 110b of the ground electrodes 110 and the distal end portion 140c of the insulator 140, and creeping discharge is generated between the distal end portion 140c of the insulator 140 and the distal end side surface 120c of the center electrode 120 along the distal end face 140d and the distal end side surface 140e of the insulator 140.

Notably, in the spark plug 100, when surface fouling little progresses on the surface of the distal end portion 140c of the insulator 140, spark discharge is generated across the first gap g1 at high frequency. When fouling progresses, spark discharge is generated across the second gap g2 at high frequency. Thus, when fouling progresses, a fouling substance such as carbon can be burned off by means of creeping discharge along the distal end face 140d and the distal end side surface 140e of the insulator 140, whereby excellent fouling resistance is exhibited.

As mentioned previously, the spark plug 100 is configured such that the distal end face 110b of each ground electrode 110 faces the facing portion 120h of the center electrode 120—the facing portion 120h being a portion of the distal end side surface 120c of the center electrode 120 (see FIG. 3). Thus, spark discharges S1 and S2 concentrate on the facing portions 120h of the distal end side surface 120c of the center electrode 120; consequently, erosion concentrates on the facing portions 120h. Furthermore, as shown in FIG. 3, spark discharge S2 in the form of creeping discharge concentrates on distal intervenient-portions 140h (hatched portions in FIG. 3) of the distal end face 140d of the insulator 140 and side intervenient-portions 140i of the distal end side surface 140e of the insulator 140—the distal intervenient-portions 140h and the side intervenient-portions 140i intervening between the distal end faces 110b of the ground electrode 110 and the corresponding facing portions 120h of the center electrode 120. Thus, channeling concentrates on the distal intervenient-portions 140h and the side intervenient-portions 140i of the insulator 140. As a result, particularly, a semi-creeping-discharge spark plug such as the spark plug 100 involves the problems of erosion of the center electrode and channeling of the insulator.

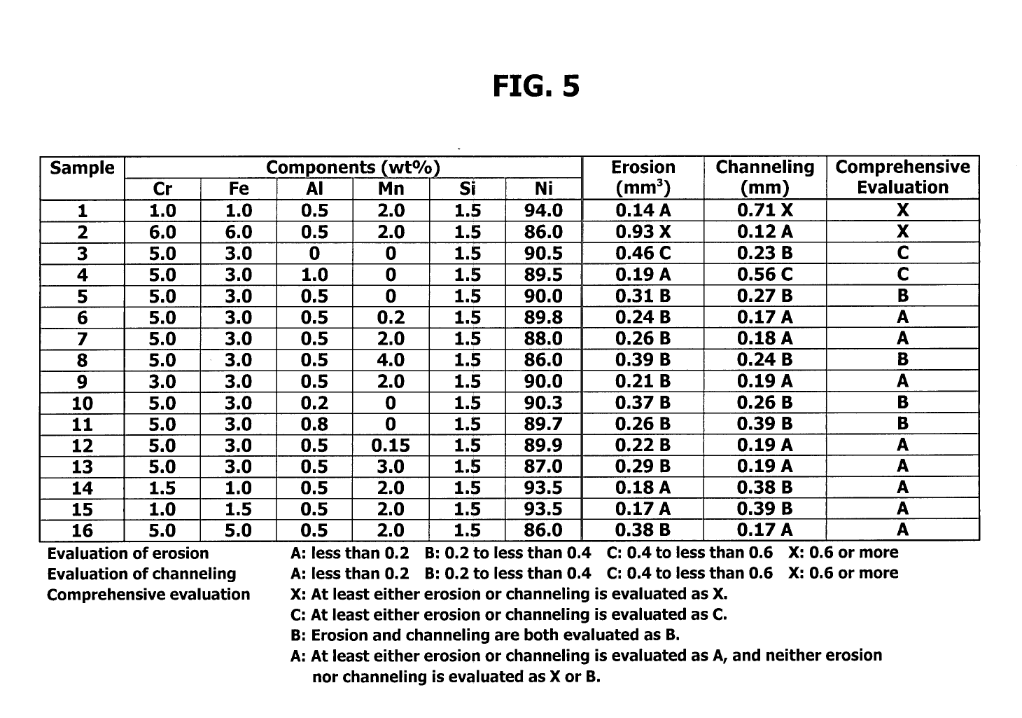

16 kinds of spark plugs 100; i.e., Samples 1 to 16, were prepared such that the components of an Ni alloy used to form the distal end portion 120b of the center electrode 120 were changed among them. Samples 1 to 16 were tested for erosion resistance of the center electrode 120 and channeling resistance of the insulator 140. Specifically, each of spark plug Samples 1 to 16 was mounted on a 4-cylinder gasoline engine (a piston displacement of 1,800 cc). The engine was operated at an engine speed of 6,000 rpm in a full throttle state for 200 hours while using unleaded high-octane gasoline as fuel. Subsequently, the volume of erosion of the center electrode 120 was measured by use of a three-dimensional laser measuring device to thereby evaluate erosion resistance of the center electrode 120. Furthermore, the channeling depth of the insulator 140 was measured by use of the three-dimensional measuring device to thereby evaluate channeling resistance of the insulator 140. The test results are shown in the table of FIG. 5. Notably, a high discharge voltage was applied to the spark plug 100 such that the center electrode 120 served as a negative electrode, and the ground electrodes 110 served as a positive electrode.

First, the test results of spark plug Sample 3 will be studied. In spark plug Sample 3, the Ni alloy contains, as secondary components, Cr in an amount of 5.0 wt % and Fe in an amount of 3,0 wt %, but does not contain Al. Spark plug Sample 3 exhibits a channeling depth of the insulator 140 of 0.23 mm, thus exhibiting good channeling resistance.

Conceivably, this exhibition of good channeling resistance results from the following. First, as shown in FIG. 4A, the generation of spark discharge S1 or S2 ionizes gas molecules present between the distal end face 110b of each ground electrode 110 and the distal end side surface 120c of the center electrode 120. The gradient of electric field formed between the ground electrode 110 and the center electrode 120 causes the above-mentioned ions to impinge on the distal end side surface 120c of the center electrode 120, thereby causing sputtering of metal components (Fe, Cr, and the like) of the distal end side surface 120c (Ni alloy) of the center electrode 120. Usually, since a combustion gas establishes a hot oxidizing atmosphere within a combustion chamber, sputtering metal components such as Fe and Cr immediately become oxides, which adhere to the distal end face 140d and the distal end side surface 140e of the insulator 140 and form a coating layer 160. Since the oxides of Fe and Cr form semiconductors, the coating layer 160 is electrically conductive. As a result, as shown in FIG. 4B, even when creeping discharge is generated along the distal end face 140d and the distal end side surface 140e of the insulator 140, the coating layer 160 protects the distal end face 140d and the distal end side surface 140e and brings about a reduction in discharge voltage, thereby suppressing channeling.

This phenomenon can be said to be a mechanism resembling reactive sputtering in which the distal end side surface 120c (Ni alloy) of the center electrode 120 serves as a target. Notably, as in the case of high-speed or heavy-load operation, when the distal end side surface 120c of the center electrode 120 and the distal end faces 110b of the ground electrodes 110—which serve as spark surfaces-are likely to increase in temperature, sputtering evaporation tends to occur on the distal end side surface 120c of the center electrode 120, thereby accelerating the formation of the coating layer 160. In other words, under the condition that channeling is more likely to occur, the formation of the coating layer 160 is more accelerated, whereby the excellent effect of suppressing channeling can be expected to be obtained. This is also described in the aforementioned Japanese Patent Application Laid-Open No. 2002-164146.

However, in spark plug Sample 3, the center electrode 120 exhibits a large volume of erosion of 0.46 mm³. A conceivable reason for the test result is the following. Since the Ni alloy containing Fe and Cr, which have low thermal conductivities, is used to form the distal end portion 120b of the center electrode 120, the thermal conductivity of the distal end portion 120b of the center electrode 120 lowers, thereby accelerating erosion of the center electrode 120.

Tests were performed for Spark plug Samples 4, 5, 10, and 11 in which Al, which has high thermal conductivity, was added in order to suppress erosion of the center electrode 120.

In spark plug Sample 4, the distal end portion 120b of the center electrode 120 is formed of a Ni alloy which contains Cr in an amount of 5.0 wt % and Fe in an amount of 3.0 wt % as in the case of spark plug Sample 3 and additionally contains Al in an amount of 1.0 wt %. Spark plug Sample 4 exhibits a good test result in terms of the volume of erosion of the center electrode 120, which is 0.19 mm³, thereby confirming that using an Ni alloy containing Al to form the distal end portion 120b of the center electrode 120 can suppress erosion of the center electrode 120. However, the insulator 140 exhibits a great channeling depth of 0.56 mm. A conceivable reason for the test results is the following. Since the coating layer 160 formed on the insulator 140 contains an oxide of Al (Al₂O₃), which is highly electrically insulative, the electrical conductivity of the coating layer 160 lowers.

By contrast, in spark plug Sample 5, the distal end portion 120b of the center electrode 120 is formed of a Ni alloy which contains Cr in an amount of 5.0 wt % and Fe in an amount of 3.0 wt % as in the case of spark plug Sample 3 and additionally contains Al in an amount of 0.5 wt %. Spark plug Sample 5 exhibits good test results in terms of the volume of erosion of the center electrode 120, which is 0.31 mm³, and in terms of the channeling depth of the insulator 140, which is 0.27 mm. A conceivable reason for the test results is the following. Through addition of Al in an amount of 0.5 wt % as a secondary component of the Ni alloy, a reduction in the thermal conductivity of the distal end portion 120b of the center electrode 120 which would otherwise result from addition of Fe and Cr is suppressed, and the amount of a highly electrically insulative oxide of Al (Al₂O₃) contained in the coating layer 160 is suppressed, whereby the electrical conductivity of the coating layer 160 can be maintained.

In spark plug Samples 10 and 11, the distal end portion 120b of the center electrode 120 is formed of an Ni alloy which contains Cr in an amount of 5.0 wt % and Fe in an amount of 3.0 wt % as in the case of spark plug Sample 3 and additionally contains Al in an amount of 0.2 wt % and 0.8 wt %, respectively. Spark plug Samples 10 and 11 also exhibits good test results in terms of the volume of erosion of the center electrode 120, which are 0.37 mm³ and 0.26 mm³, respectively, and in terms of the channeling depth of the insulator 140, which are 0.26 mm and 0.39 mm, respectively.

The above-mentioned test results of spark plug Samples 3, 4, 5, 10, and 11 reveal that, in order to suppress erosion of the center electrode 120, an Al content of the Ni alloy of 0.2 wt % or more is preferred. This is because, through addition of Al, which is highly thermally conductive, in an amount of 0.2 wt % or more as a secondary component of the Ni alloy, a reduction in the thermal conductivity of the Ni alloy which would otherwise result from addition of Fe and Cr can be suppressed. On the other hand, in order to suppress channeling of the insulator 140, the Al content of the Ni alloy is preferably limited to 0.8 wt % or less. This is because, through employment of an Al content of 0.8 wt % or less, the amount of a highly electrically insulative oxide of Al (Al₂O₃) contained in the coating layer 160 formed on the distal end face 140d and the distal end side surface 140e of the insulator 140 is suppressed, whereby the electrical conductivity of the coating layer 160 can be maintained. Therefore, preferably, the Al content of the Ni alloy is 0.2 wt % to 0.8 wt %.

Next, the test results of spark plug Samples 5 to 8, 12, and 13 will comparatively be studied. In spark plug Samples 5 to 8, 12, and 13, the respective Ni alloys used to form the distal end portion 120b of the center electrode 120 contain Cr in an amount of 5.0 wt % and Fe in an amount of 3.0 wt % and additionally contain Al in an amount of 0.5 wt %, but differ in the Mn content.

In spark plug Sample 6, the Ni alloy used to form the distal end portion 120b of the center electrode 120 contains Mn as a secondary component in an amount of 0.2 wt %. Spark plug Sample 6 exhibits a good test result in terms of the volume of erosion of the center electrode 120, which is 0.24 mm³, and a very good test result in terms of the channeling depth of the insulator 140, which is 0.17 mm. As compared with spark plug Sample 5 in which the Ni alloy does not contain Mn, spark plug Sample 6 is enhanced in erosion resistance of the center electrode 120 and channeling resistance of the insulator 140.

A conceivable reason for such enhancement is the following: as described in the publication “The Actualities of Temperature Sensitive Semiconductors”(written by Hisao NIKI, published by Sanpo), p. 20, an oxide of Al is combined with an oxide of Mn to thereby form a composite oxide semiconductor. Specifically, through addition of Mn as a secondary component of the Ni alloy, the coating layer 160 can contain a composite oxide semiconductor consisting of an oxide of Al and an oxide of Mn, in place of a highly electrically insulative oxide of Al (Al₂O₃), thereby enhancing the electrical conductivity of the coating layer 160 with a resultant reduction in discharge voltage. Notably, in spark plug Sample 6, the Ni alloy used to form the distal end portion 120b of the center electrode 120 contains Mn and Al such that the Mn content (wt %) is 0.4 times the Al content (wt %).

In spark plug Sample 7, the Ni alloy used to form the distal end portion 120b of the center electrode 120 contains Mn as a secondary component in an amount of 2.0 wt %. Spark plug Sample 7 exhibits a good test result in terms of the volume of erosion of the center electrode 120, which is 0.26 mm³, and a very good test result in terms of the channeling depth of the insulator 140, which is 0.18 mm. Spark plug Sample 7 can be said to have erosion resistance of the center electrode 120 and channeling resistance of the insulator 140 substantially equivalent to those of above-mentioned spark plug Sample 6. Notably, in spark plug Sample 7, the Ni alloy used to form the distal end portion 120b of the center electrode 120 contains Mn and Al such that the Mn content (wt %) is 4.0 times the Al content (wt %).

In spark plug Samples 12 and 13, the Ni alloy used to form the distal end portion 120b of the center electrode 120 contains Mn as a secondary component in an amount of 0.15 wt % and 3.0 wt %, respectively. Spark plug Samples 12 and 13 exhibit a good test result in terms of the volume of erosion of the center electrode 120, which are 0.22 mm³ and 0.29 mm³, respectively, and a very good test result in terms of the channeling depth of the insulator 140, which is 0.19 mm. Spark plug Samples 12 and 13 can also be said to have erosion resistance of the center electrode 120 and channeling resistance of the insulator 140 substantially equivalent to those of above-mentioned spark plug Sample 6. Notably, in spark plug Samples 12 and 13, the Ni alloy used to form the distal end portion 120b of the center electrode 120 contains Mn and Al such that the Mn content (wt %) is 0.3 times and 6.0 times, respectively, the Al content (wt %).

In spark plug Sample 8, the Ni alloy used to form the distal end portion 120b of the center electrode 120 contains Mn as a secondary component in an amount of 4.0 wt %. Spark plug Sample 8 exhibits a good test result in terms of the channeling depth of the insulator 140, which is 0.24 mm, but exhibits a large volume of spark erosion of the center electrode 120 of 0.39 mm³. A conceivable reason for the test results is the following. An increase in the content of Mn contained in the Ni alloy as a secondary component causes a reduction in the thermal conductivity of the distal end portion 120b of the center electrode 120; consequently, the erosion resistance of the center electrode 120 cannot be ensured. Notably, in spark plug Sample 8, the Ni alloy used to form the distal end portion 120b of the center electrode 120 contains Mn and Al such that the Mn content (wt %) is 8 times the Al content (wt %).

The above-mentioned test results of spark plug Samples 5, 6, 7, 8, 12, and 13 reveal that, preferably, in order to effectively suppress channeling of the insulator 140, the Mn content (wt %) of the Ni alloy is 0.3 times or more the Al content (wt %). Conceivably, this is because a composite oxide semiconductor which consists of an oxide of Al and an oxide of Mn and which is effective for suppression of channeling can be formed on the distal end face 140d and the distal end side surface 140e of the insulator 140. Furthermore, in order to suppress erosion of the center electrode 120, the Mn content (wt %) of the Ni alloy is preferably limited to 6.0 times or less the Al content (wt %). Conceivably, this is because, through limitation of the Mn content to 6.0 times or less the Al content, the erosion resistance of the center electrode 120 can be ensured. Therefore, preferably, the Ni alloy used to form the distal end portion 120b of the center electrode 120 contains Mn and Al such that the Mn content (wt %) is 0.3 times to 6.0 times the Al content (wt %).

Notably, the present embodiment selects Mn as a metal element which is used to form a composite oxide semiconductor in combination with an oxide of Al. However, in place of Mn, Co or Cu may be used. The aforementioned publication “The Actualities of Temperature Sensitive Semiconductors” (written by Hisao NIKI, published by Sanpo), p. 20, also describes that, in combination with an oxide of Al, an oxide of Co or Cu also forms a composite oxide semiconductor. Furthermore, according to the publication, when Co or Cu is contained such that the weight ratio of Co or Cu to Al is equal to that in the case of addition of Mn, the resistivity of a composite oxide semiconductor is substantially equivalent to that in the case of addition of Mn. Thus, as in the case of addition of Mn, when the Ni alloy used to form the distal end portion 120b of the center electrode 120 is to contain Co or Cu, the Co or Cu content (wt %) is rendered 0.3 times to 6.0 times the Al content (wt %), whereby, while channeling of the insulator 140 is effectively suppressed, the erosion resistance and thermal resistance of the center electrode 120 are ensured. Notably, not a single element, but two or more elements of Mn, Co, and Cu may be contained. In this case, preferably, the total of their contents (wt %) is 0.3 times to 6.0 times the Al content (wt %).

Next, the test results of spark plug Samples 1, 2, 7, 9, 14, 15, and 16 will comparatively be studied. In spark plug Samples 1, 2, 7, 9, 14, 15, and 16, the respective Ni alloys used to form the distal end portion 120b of the center electrode 120 contain, as secondary components, Al in an amount of 0.5 wt % and Mn in an amount of 2.0 wt %, but differ in the Cr and Fe contents.

In spark plug Sample 1, the distal end portion 120b of the center electrode 120 is formed of a Ni alloy which contains Cr in an amount of 1.0 wt % and Fe in an amount of 1.0 wt % and thus contains Cr and Fe in a total amount of 2.0 wt %. Spark plug Sample 1 exhibits a good test result in terms of the volume of erosion of the center electrode 120, which is 0.14 mm³, but exhibits an extremely great channeling depth of the insulator 140 of 0.71 mm. A conceivable reason for the test results is the following. Since, among secondary components of the Ni alloy, Cr and Fe are contained in small amounts, the thermal conductivity of the distal end portion 120b of the center electrode 120 does not lower to thereby ensure erosion resistance, but oxide semiconductors contained in the coating layer 160 decrease, with a resultant impairment in channeling resistance.

On the other hand, in spark plug Sample 2, the distal end portion 120b of the center electrode 120 is formed of an Ni alloy which contains, as secondary components, Cr in an amount of 6.0 wt % and Fe in an amount of 6.0 wt % and thus contains Cr and Fe in a total amount of 12.0 wt %. Spark plug Sample 2 exhibits a very good test result in terms of the channeling depth of the insulator 140, which is 0.12 mm, but exhibits a very large volume of erosion of the center electrode 120 of 0.93 mm³. A conceivable reason for the test results is the following. In contrast to spark plug Sample 1, since, among secondary components of the Ni alloy, Cr and Fe are contained in large amounts, oxide semiconductors contained in the coating layer 160 increase to thereby enhance channeling resistance, but the thermal conductivity of the distal end portion 120b of the center electrode 120 lowers, with a resultant impairment in erosion resistance.

By contrast, in spark plug Sample 7, the distal end portion 120b of the center electrode 120 is formed of an Ni alloy which contains, as secondary components, Cr in an amount of 5.0 wt % and Fe in an amount of 3.0 wt % and thus contains Cr and Fe in a total amount of 8.0 wt %. As mentioned previously, spark plug Sample 7 exhibits a good test result in terms of the volume of erosion of the center electrode 120, which is 0.26 mm³, and exhibits a very good test result in terms of the channeling depth of the insulator 140, which is 0.18 mm. A conceivable reason for the test results is the following. Since the Ni alloy used to form the distal end portion 120b of the center electrode 120 contains, as secondary components, Cr in an amount of 5.0 wt % and Fe in an amount of 3.0 wt % and thus contains Cr and Fe in a total amount of 8.0 wt %, while oxide semiconductors contained in the coating layer 160 enhance channeling resistance, a reduction in the thermal conductivity of the distal end portion 120b of the center electrode 120 is suppressed, whereby erosion resistance can be ensured.

In spark plug Sample 9, the distal end portion 120b of the center electrode 120 is formed of an Ni alloy which contains, as secondary components, Cr in an amount of 3.0 wt % and Fe in an amount of 3.0 wt % and thus contains Cr and Fe in a total amount of 6.0 wt %. Spark plug Sample 9 exhibits a good test result in terms of the volume of erosion of the center electrode 120, which is 0.21 mm³, and exhibits a very good test result in terms of the channeling depth of the insulator 140, which is 0.19 mm. Spark plug Sample 9 can be said to have erosion resistance of the center electrode 120 and channeling resistance of the insulator 140 substantially equivalent to those of above-mentioned Sample 7.

In spark plug Samples 14 and 15, the distal end portion 120b of the center electrode 120 is formed of an Ni alloy which contains, as secondary components, Cr in an amount of 1.5 wt % and 1.0 wt %, respectively, and Fe in an amount of 1.0 wt % and 1.5 wt %, respectively, and thus contains Cr and Fe in a total amount of 2.5 wt %. Spark plug Samples 14 and 15 exhibit very good test results in terms of the volume of erosion of the center electrode 120, which are 0.18 mm³ and 0.17 mm³, respectively, and exhibit good test results in terms of the channeling depth of the insulator 140, which are 0.38 mm and 0.39 mm, respectively.

In spark plug Sample 16, the distal end portion 120b of the center electrode 120 is formed of an Ni alloy which contains, as secondary components, Cr in an amount of 5.0 wt % and Fe in an amount of 5.0 wt % and thus contains Cr and Fe in a total amount of 10.0 wt %. Spark plug Sample 16 exhibits a good test result in terms of the volume of erosion of the center electrode 120, which is 0.38 mm³, and exhibits a very good test result in terms of the channeling depth of the insulator 140, which is 0.17 mm.

The above-mentioned test results of spark plug Samples 1, 2, 7, 9, 14, 15, and 16 reveal that, preferably, in order to suppress channeling of the insulator 140, an Ni alloy used to form the distal end portion 120b of the center electrode 120 contains Cr and Fe as secondary components such that at least one of Cr and Fe is contained in an amount of 1.5 wt % or more, and Cr and Fe are contained in a total amount of 2.5 wt % or more. Conceivably, this is because, through addition of the components in such an adjusted manner, a reduction in the electrical conductivity of the coating layer 160 stemming from, particularly, inclusion of a highly electrically insulative oxide of Al (Al₂O₃) can be suppressed, and channeling resistance can be enhanced. Furthermore, preferably, in order to suppress erosion of the center electrode 120, the Ni alloy used to form the distal end portion 120b of the center electrode 120 contains, as secondary components, Cr in an amount of 5.0 wt % or less and Fe in an amount of 5.0 wt % or less and contains Cr and Fe in a total amount of 10.0 wt % or less. This is because, through addition of the components in such an adjusted manner, a reduction in the thermal conductivity of the distal end portion 120b of the center electrode 120 is suppressed, whereby erosion resistance can be ensured.

Meanwhile, as mentioned previously, in the spark plug 100 according to the present embodiment, the center electrode 120 includes the core member 122 formed of Cu, and the distal end portion 122b of the core member 122 is covered with the covering member 121 formed of an Ni alloy (see FIG. 2). The core member 122 formed of Cu is greater in coefficient of thermal expansion than the covering member 121 formed of a Ni alloy and covering the core member 122. Thus, in actual use of the spark plug 100, the radially outward thermal expansion of the core member 122 may cause a peripheral covering portion 121d of the covering member 121 located around the periphery of the core member 122 to expand radially outward to a greater extent as compared with characteristic thermal expansion of an Ni alloy. Meanwhile, a distal covering portion 121b of the covering member 121 located on the distal end side with respect to the distal end of the core member 122 thermally expands radially outward at a rate characteristic to an Ni alloy without being influenced by radially outward thermal expansion of the core member 122. For this reason, the covering member 121 may involve the following problem: the peripheral covering portion 121d expands radially outward to a greater extent as compared with the distal covering portion 121b and leads to deformation, and the distal end portion 120b of the center electrode 120 is deformed in such a manner as to sink toward the proximal side (downward in FIG. 2).

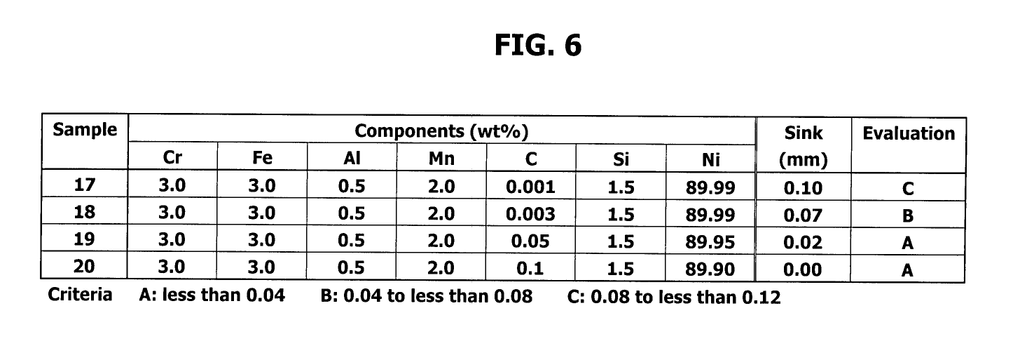

In an attempt to suppress sink on the distal end portion 120b stemming from the radially outward thermal expansion of the core member 122 by means of adding C to an Ni alloy used to form the covering member 121 of the center electrode 120 so as to enhance the hot strength of the Ni alloy, the following studies were conducted. Four kinds of spark plugs; i.e., Samples 17 to 20, were prepared in a manner similar to that for preparation of aforementioned Sample 9 except that the Ni alloy used to form the covering member 121 of the center electrode 120 contained C as a secondary component in an adjusted amount. Spark plug Samples 17 to 20 were tested for the amount of sink on the center electrode 120. Specifically, spark plug Samples 17 to 20 were subjected to 2,500 heat cycles. In each heat cycle, each of spark plug Samples 17 to 20 was heated to 850° C. by use of a burner, was held heated at that temperature for three minutes, and then was air-cooled for one minute. Subsequently, the amount of sink on the center electrode 120 was measured for evaluation of sink resistance. The test results are shown in the table of FIG. 6.

Spark plug Samples 17 to 20 use respective Ni alloys, which differ in C content only and are identical in other secondary component contents, to form the covering member 121 of the center electrode 120. In spark plug Sample 17, a Ni alloy which contains C as a secondary component in an amount of 0.001 wt % is used to form the covering member 121 of the center electrode 120. Spark plug Sample 17 exhibits a large amount of sink on the center electrode 120 of 0.10 mm. Conceivably, this is because a C content of 0.001 wt % fails to impart sufficient hot strength to the Ni alloy, with a resultant failure to suppress radially outward deformation of the peripheral covering portion 121d of the covering member 121 of the center electrode 120 stemming from thermal expansion of the core member 122.

By contrast, in spark plug Sample 18, a Ni alloy which contains C as a secondary component in an amount of 0.003 wt % is used to form the covering member 121 of the center electrode 120. In spark plug Sample 18, the amount of sink on the center electrode 120 is suppressed to 0.07 mm. Conceivably, this is because a C content of 0.003 wt % can enhance the hot strength of the Ni alloy, thereby suppressing radially outward deformation of the peripheral covering portion 121d of the covering member 121 stemming from thermal expansion of the core member 122.

Furthermore, in spark plug Sample 19, a Ni alloy which contains C as a secondary component in an amount of 0.05 wt % is used to form the covering member 121 of the center electrode 120. Spark plug Sample 19 exhibits a very small amount of sink on the center electrode 120 of 0.02 mm. Also, in spark plug Sample 20, a Ni alloy which contains C as a secondary component in an amount of 0.1 wt % is used to form the covering member 121 of the center electrode 120. In spark plug Sample 20, the amount of sink on the center electrode 120 is 0.00 mm; i.e., no sink is formed.

The above-mentioned test results of spark plug Samples 17 to 20 reveal that, when an Ni alloy used to form the covering member 121 of the center electrode 120 contains C as a secondary component in an amount of 0.003 wt % or more, sink on the center electrode 120 can be suppressed. However, in spark plug Sample 20 employing a C content of 0.1 wt %, hardness of the Ni alloy was excessively high, and thus formation of the center electrode 120 was difficult. Therefore, more preferably, the C content of a Ni alloy used to form the covering member 121 of the center electrode 120 is 0.003 wt % to 0.05 wt %.

First Modification:

Next, a spark plug 200, which is a first modification of the spark plug 100 according to the embodiment, will be described with reference to the drawings. The spark plug 200 of the first modification is substantially similar to the spark plug 100 of the embodiment except for the structure of a distal end portion of the plug. Therefore, portions different from those of the embodiment will mainly be described, and description of similar portions will be omitted or briefed.

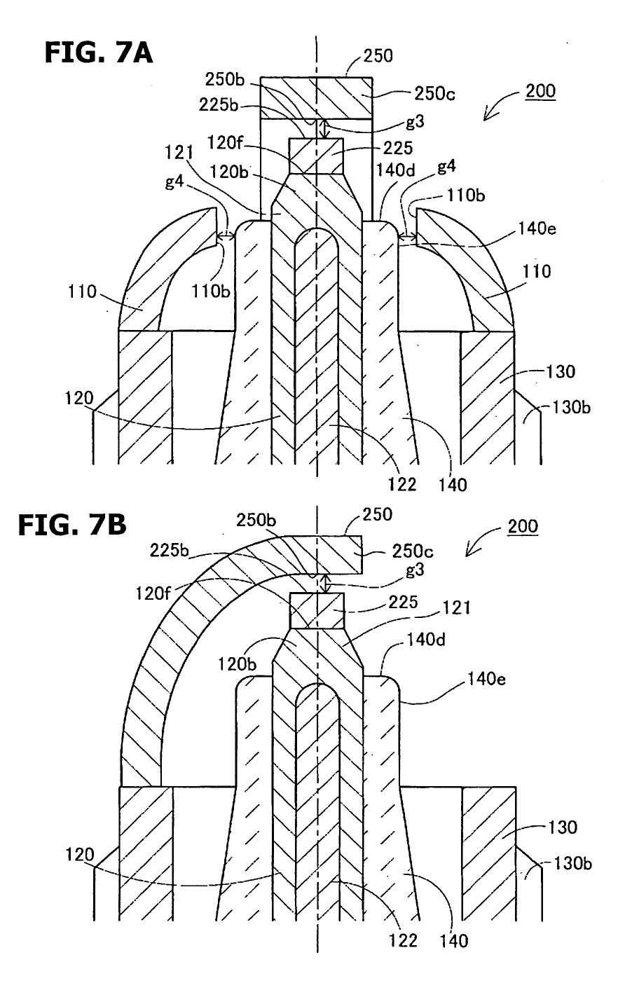

FIGS. 7A and 7B are sectional views showing a distal end portion of the spark plug 200 according to the first modification, wherein FIG. 7A is a sectional front view, and FIG. 7B is a sectional side view. The spark plug 200 includes a parallel electrode 250 in addition to the two ground electrodes 110 of the spark plug 100 according to the embodiment. Furthermore, in order to enhance ignition performance and durability, a metal chip 225 is provided on the tip of the distal end portion 120b of the center electrode 120 (the metal chip 225 does not constitute (i.e., is not a portion of) the distal end portion 120b of the center electrode 120). Specifically, the disklike metal chip 225 is laser-welded to a distal end face 120f of the center electrode 120. The metal chip 225 is formed of, for example, an alloy which contains a noble metal, such as Pt, Ir, or Rh, as a primary component, or an alloy which contains a high-melting-point metal, such as W, as a primary component.

As shown in FIG. 7B, the parallel electrode 250 is formed such that a distal end portion 250c faces a distal end face 225b of the metal chip 225. Furthermore, a facing surface 250b of the distal end portion 250c of the parallel electrode 250 which faces the distal end face 225b of the metal chip 225 is arranged in parallel with the distal end face 225b of the metal chip 225. In other words, the spark plug 200 is a semi-creeping-discharge spark plug combined with the parallel electrode 250. Notably, also in the spark plug 200 of the first modification, the core member 122 is disposed such that its distal end is located on the proximal side with respect to the distal end face 140d of the insulator 140, and does not extend into the distal end portion 120b of the center electrode 120. Therefore, the entire distal end portion 120b of the center electrode 120 is formed of a Ni alloy.

In the spark plug 200, the gap between the facing surface 250b of the parallel electrode 250 and the distal end face 225b of the metal chip 225 is called a gap g3; and the gap between the distal end face 110b of each ground electrode 110 and the distal end side surface 140e of the insulator 140 is called a gap g4. Spark discharge is performed across the gaps g3 and g4. When the distal end face 140d and the distal end side surface 140e of the insulator 140 are fouled, spark discharge tends to be performed across the gap g4 between the distal end face 110b of each ground electrode 110 and the distal end side surface 140e of the insulator 140. Thus, creeping discharge may frequently be generated along the distal end face 140d and the distal end side surface 140e of the insulator 140, possibly resulting in channeling of the insulator 140 and erosion of the center electrode 120.

Therefore, as in the case of the embodiment, also in the spark plug 200 according to the first modification, through adjustment of the components of an Ni alloy used to form the covering member 121 of the center electrode 120, erosion of the center electrode 120 and channeling of the insulator 140 can concurrently be suppressed. Specifically, preferably, the Ni alloy contains Cr and Fe as secondary components such that at least one of Cr and Fe is contained in an amount of 1.5 wt % or more and such that Cr and Fe are contained in a total amount of 2.5 wt % to 10.0 wt %, and further contains Al in an amount of 0.2 wt % to 0.8 wt %. Furthermore, preferably, the Ni alloy contains at least one of Mn, Co, and Cu as a secondary component such that the total of their contents is 0.3 times to 6.0 times the Al content, whereby channeling resistance can be more enhanced. Also, preferably, the Ni alloy contains C as a secondary component in an amount of 0.003 wt % to 0.05 wt %, whereby, while good formability of the center electrode 120 is maintained, sink on the center electrode 120 can be suppressed.

As mentioned previously, in the spark plug 200, the metal chip 225—which is formed of an alloy which contains a noble metal, such as Pt, Ir, or Rh, as a primary component, or an alloy which contains a high-melting-point metal, such as W, as a primary component—is laser-welded to the distal end face 120f of the center electrode 120. Generally, weldability is rather poor in welding an Ni alloy which contains Ni in an amount of 80 wt % or more and Fe and Cr in a total amount of 2.5 wt % to 10.0 wt %, such as an Ni alloy used to form the distal end portion 120b of the center electrode 120, and an alloy which contains a noble metal, such as Pt, Ir, or Rh, as a primary component or which contains a high-melting-point metal, such as W, as a primary component. Thus, in such a spark plug, the metal chip 225 may be prone to come off.

By contrast, in the spark plug 200 according to the first modification, the metal chip 225 assumes a diameter of 0.8 mm or less, thereby alleviating potential occurrence of defective weld or a like problem. As a result, the metal chip 225 becomes unlikely to come off.

Second Modification:

Next, a spark plug 300, which is a second modification of the spark plug 100 according to the embodiment, will be described with reference to the drawings. The spark plug 300 of the second modification is substantially similar to the spark plug 100 of the embodiment except for the structure of a distal end portion of the plug. Therefore, portions different from those of the embodiment will mainly be described, and description of similar portions will be omitted or briefed.

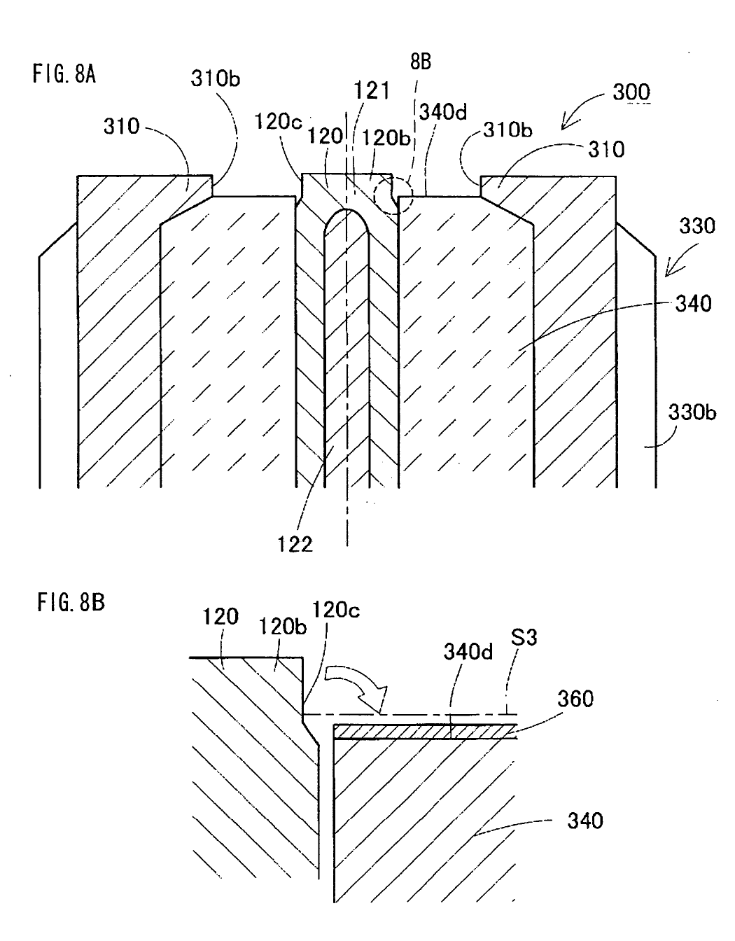

FIG. 8A is a sectional view showing a distal end portion of the spark plug 300 according to the second modification. The spark plug 300 includes an annular ground electrode 310, which is arranged such that a distal end face 310b of the annular ground electrode 310 and a distal end face 340d of an insulator 340 are in contact with each other. The spark plug 300 is a so-called full-creeping-discharge spark plug; i.e., creeping discharge S3 (see FIG. 8B) occurs along the distal end face 340d of the insulator 340 over the substantially overall discharge path between the distal end face 310b of the ground electrode 310 and the distal end side surface 120c of the center electrode 120. Thus, the spark plug 300 also involves potential occurrence of channeling of the insulator 340 and erosion of the center electrode 120. Notably, also in the spark plug 300 of the second modification, the core member 122 is disposed such that its distal end is located on the proximal side with respect to the distal end face 340d of the insulator 340, and does not extend into the distal end portion 120b of the center electrode 120. Therefore, the entire distal end portion 120b of the center electrode 120 is formed of a Ni alloy.

Therefore, as in the case of the embodiment, also in the spark plug 300 according to the second modification, through adjustment of the components of an Ni alloy used to form the covering member 121 of the center electrode 120, erosion of the center electrode 120 and channeling of the insulator 340 can concurrently be suppressed. Specifically, preferably, the Ni alloy contains Cr and Fe as secondary components such that at least one of Cr and Fe is contained in an amount of 1.5 wt % or more and such that Cr and Fe are contained in a total amount of 2.5 wt % to 10.0 wt %, and further contains Al in an amount of 0.2 wt % to 0.8 wt %. Through addition of the secondary components in such an adjusted manner, as shown in the enlarged view of FIG. 8B, a coating layer 340d resistant to channeling can be formed on the distal end face 340d of the insulator 340. Furthermore, preferably, the Ni alloy contains at least one of Mn, Co, and Cu as a secondary component such that the total of their contents is 0.3 times to 6.0 times the Al content, whereby channeling resistance can be more enhanced. Also, preferably, the Ni alloy contains C as a secondary component in an amount of 0.003 wt % to 0.05 wt %, whereby, while good formability of the center electrode 120 is maintained, sink on the center electrode 120 can be suppressed.

While the present invention has been described with reference to the embodiment and the first and second modifications, the present invention is not limited thereto, but may be modified as appropriate without departing from the spirit or scope of the invention.

For example, the embodiment and the modifications are described while mentioning a spark plug whose metallic shell 130 has the male-threaded portion 130b of a nominal size of M14. However, the present invention is not limited thereto. The present invention is particularly effective for a spark plug for use in an internal combustion engine whose metallic shell has a nominal size of M12 or smaller; for example, M12 or M10. Specifically, in a spark plug which allows creeping discharge, such as a semi-creeping-discharge spark plug, as the size (diameter) reduces, the frequency of creeping discharge increases, and the wall thickness of the insulator and the diameter of the center electrode tend to decrease. Thus, as compared with a spark plug whose metallic shell has a male-threaded portion of a nominal size of M14 or greater, a small-sized (small-diameter) spark plug having a nominal size of M12 or less is greatly influenced by channeling of the insulator and erosion of the center electrode; consequently, its performance may be greatly impaired in early stages of use. Even in the case of such a small-diameter spark plug of M12 or less, the present invention can suppress both of channeling of the insulator and erosion of the center electrode.

Therefore, through application of the present invention to a small-diameter spark plug whose metallic shell has a male-threaded portion of M12 or less; i.e., has an outside diameter of 10.1 mm or less at its distal end, particularly, channeling of the insulator and erosion of the center electrode are simultaneously suppressed, whereby spark plug life can be extended.

The similar effect can be yielded even when the present invention is applied to a spark plug whose metallic shell does not have a mounting male-threaded portion on its outer surface, or a so-called unthreaded plug.

In the above-described embodiment, the spark plug 100 assumes the form of a semi-creeping-discharge spark plug having two ground electrodes 101. However, the number of ground electrodes may be one or more. For example, the spark plug 100 may assume the form of a semi-creeping-discharge spark plug having three or four ground electrodes.

In the embodiment and the modifications described above, the core member 122 is configured such that its distal end is located on the proximal side with respect to the distal end face 140d (340d) of the insulator 140 (340) and does not extend into the distal end portion 120b of the center electrode 120. In other words, the entire distal end portion 120b of the center electrode 120 is formed of a Ni alloy. However, the core member 122 may be configured such that its distal end is located on the distal-end side with respect to the distal end face 140d (340d) of the insulator 140 (340) and is thus included in the distal end portion 120b of the center electrode 120. In other words, the entire distal end portion 120b of the center electrode 120 is not required to be formed of an Ni alloy so long as at least the surface of the distal end portion 120b is formed of an Ni alloy.

What is claimed is:

1. A spark plug for use in an internal combustion engine, comprising:
a tubular insulator having an axial hole extending therethrough in an axial direction;
a center electrode fitted into the axial hole and having a distal end portion protruding from a distal end of the insulator; and
a single or a plurality of ground electrodes located diametrally outside of the center electrode and positionally related to a distal end portion of the insulator and the distal end portion of the center electrode such that at least a portion of spark discharge generated between the ground electrode(s) and the distal end portion of the center electrode includes creeping discharge along a surface of the distal end portion of the insulator;
at least the distal end portion of the center electrode being configured such that at least a surface of the distal end portion of the center electrode is formed of an Ni alloy which contains Ni as a primary component in an amount of 80 wt % or more and Fe and Cr as secondary components in a total amount of 2.5 wt % to 10.0 wt %;
wherein the Ni alloy further contains Al as a secondary component in an amount of 0.2 wt % to 0.8 wt %.

2. A spark plug for use in an internal combustion engine according to claim 1, wherein the single ground electrode or at least one of the plurality of ground electrodes is disposed such that a distal end face of the ground electrode faces a portion of a circumferential surface of the distal end portion of the center electrode while at least a part of the distal end portion of the insulator intervenes therebetween.

3. A spark plug for use in an internal combustion engine according to claim 1, wherein the Ni alloy contains Fe, as a secondary component, in an amount of 1.5 wt % to 5.0 wt %.

4. A spark plug for use in an internal combustion engine according to claim 1, wherein the Ni alloy contains Cr, as a secondary component, in an amount of 1.5 wt % to 5.0 wt %.

5. A spark plug for use in an internal combustion engine according to claim 1, wherein the Ni alloy contains at least any one of Mn, Cu, and Co as a secondary component.

6. A spark plug for use in an internal combustion engine according to claim 5, wherein, when b represents the content (wt %) of Al, and c represents the total of Mn, Cu, and Co contents (wt %), the Ni alloy satisfies
0.3b<c<6.0b.

7. A spark plug for use in an internal combustion engine according to claim 1,
wherein the center electrode comprises a core member formed of Cu or a Cu alloy, and a covering member formed of the Ni alloy and covering at least a distal end portion of the core member such that a distal end of the core member is located on a proximal side with respect to a distal end face of the center electrode; and
the Ni alloy contains C as a secondary component in an amount of 0.003 wt % to 0.05 wt %.

8. A spark plug for use in an internal combustion engine according to any one of claims 1 to 7, further comprising a metallic shell disposed in such a manner as to surround a periphery of the insulator and such that the distal end portion of the insulator protrudes beyond a distal end face of the metallic shell,
wherein the metallic shell has an outside diameter of 10.1 mm or less at its distal end.
